(19) United States
(12) Patent Application Publication
(10) Pub. No.: US 2010/0159173 A1
(43) Pub. Date: Jun. 24, 2010

(54) Polyethylene Polymerization Processes

(75) Inventors: John Ashbaugh, Houston, TX (US); Brian B. Cole, Kingwood, TX (US); David Rauscher, Angleton, TX (US); Gerhard Guenther, Kemah, TX (US); Michael McLeod, Kemah, TX (US); Ruby L. Curtis, League City, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 12/419,749

(22) Filed: Apr. 7, 2009

Related U.S. Application Data
(60) Provisional application No. 61/138,835, filed on Dec. 18, 2008.

(51) Int. Cl. B32B 1/08; C08F 8/00

(52) U.S. Cl. 428/36.9; 525/366

(57) ABSTRACT

Polymer articles and processes of forming the same are described herein. The processes generally include providing a bimodal ethylene based polymer, blending the bimodal ethylene based polymer with a nucleator to form modified polyethylene and forming the modified polyethylene into a polymer article, wherein the polymer article is selected from pipe articles and blown films.

### CROSS-REFERENCE TO RELATED APPLICATIONS

This application claims the benefit of U.S. Provisional Patent Application Ser. No. 61/138,835, filed Dec. 18, 2008.

### FIELD

Embodiments of the present invention generally relate to articles formed with polyethylene. In particular, embodiments of the present invention generally relate to articles formed with nucleated bimodal polyethylene.

### BACKGROUND

As reflected in the patent literature, propylene polymers have been nucleated for a variety of applications, such as injection molding, rotomolding, blown film, extruding, and solid state stretching processes, for example, with demonstrated improvements in processing and the resulting article's properties. However, nucleation of ethylene polymers has generally not experienced the same improvements due, at least in part, to polyethylene's high initial crystal growth rate. Prior attempts to nucleate polyethylene have therefore been focused on the utilization of specific nucleators in combination with linear low density polyethylene. While success (as measured by increasing crystallization rates) has been achieved with linear low density polyethylene, the ability to nucleate other polyethylenes, such as medium and high density polyethylene have not been demonstrated.

In addition, pipe articles, thermoformed articles, corrugated sheet and other profile extrusion articles formed with ethylene based polymers may exhibit a less than desired sag resistance. Further, blown films formed with ethylene based polymers, and in particular high molecular weight, high density ethylene based polymers, may exhibit bubble instability during processing, resulting in blown films having defects and/or processing difficulties.

Therefore, a need exists to develop ethylene based polymers and processes exhibiting improved properties and processing.

### SUMMARY

Embodiments of the present invention include processes of forming polymer articles. The processes generally include providing a bimodal ethylene based polymer, blending the bimodal ethylene based polymer with a nucleator to form modified polyethylene and forming the modified polyethylene into a polymer article, wherein the polymer article is selected from pipe articles and blown films.

Embodiments of the invention further include pipe articles and blown films formed by the processes described herein.

### BRIEF DESCRIPTION OF DRAWINGS

FIG. 1 illustrates the sag resistance obtained at varying take up speeds of various pipe samples.

FIG. 2 illustrates the gauge profiles of various film samples

FIG. 3 illustrates the gauge profiles various film samples.

FIG. 4 illustrates the gloss of various film samples.

FIG. 5 illustrates the haze of various film samples.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

### Catalyst Systems

Catalyst systems useful for polymerizing olefin monomers include any suitable catalyst system. For example, the catalyst system may include chromium based catalyst systems, single site transition metal catalyst systems including metallocene catalyst systems, Ziegler-Natta catalyst systems or combinations thereof for example. The catalysts may be activated for subsequent polymerization and may or may not be associated with a support material, for example. A brief discussion of such catalyst systems is included below, but is in no way intended to limit the scope of the invention to such catalysts.

For example, Ziegler-Natta catalyst systems are generally formed from the combination of a metal component (e.g., a catalyst) with one or more additional components, such as a catalyst support, a cocatalyst and/or one or more electron donors, for example.

One or more embodiments of the invention include Ziegler-Natta catalyst systems generally formed by contacting an alkyl magnesium compound with an alcohol to form a magnesium dialkoxide compound and then contacting the magnesium dialkoxide compound with successively stronger chlorinating agents. (See. U.S. Pat. No. 6,734,134 and U.S. Pat. No. 6,174,971, which are incorporated herein by reference.)

Metallocene catalysis may be characterized generally as coordination compounds incorporating one or more cyclopentadienyl (Cp) groups (which may be substituted or unsubstituted, each substitution being the same or different) coordinated with a transition metal through π bonding. The substituent groups on Cp may be linear, branched or cyclic hydrocarbyl radicals, for example. The cyclic hydrocarbyl radicals may further form other contiguous ring structures, including indenyl, azulenyl and fluorenyl groups, for example. These contiguous ring structures may also be substituted or unsubstituted by hydrocarbyl radicals, such as C₁ to C₂₀ hydrocarbyl radicals, for example.

One or more embodiments of the invention include metallocene catalyst systems including indenyl ligands. For example, the metallocene catalyst systems may include tetra hydro indenyl ligands.

### Polymerization Processes

As indicated elsewhere herein, catalyst systems are used to form polyolefin compositions. Once the catalyst system is prepared, as described above and/or as known to one skilled in the art, a variety of processes may be carried out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6.420,580; U.S. Pat. No. 6,380,328; U.S. Pat. No. 6,359,072; U.S. Pat. No. 6,346.586; U.S. Pat. No. 6,340,730: U.S. Pat. No. 6,339,134; U.S. Pat. No. 6,300,436; U.S. Pat. No. 6,274,684: U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form polymers. The olefin monomers may include C₂ to C₃₀ olefin monomers, or C₂ to C₁₂ olefin monomers (e.g., ethylene, propylene, butene, pentene, methylpentene, hexene, octene and decene), for example. The monomers may include olefinic unsaturated monomers, C₄ to C₁₈ diolefins, conjugated or nonconjugated dienes, polyenes, vinyl monomers and cyclic olefins, for example. Non-limiting examples of other monomers may include norbornene, nobornadiene, isobutylene, isoprene, vinylbenzocyclobutane, sytrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5.236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C. or from about 70° C. to about 110° C. or from about 70° C. to about 95° C., for example. (See, for example, U.S. Pat. No. 4,543,399; U.S. Pat. No. 4,588,790; U.S. Pat. No. 5.028.670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999: U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process with the exception that the liquid medium is also the reactant (e.g., monomer) in a bulk phase process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example. Reaction heat may be removed through the loop wall via any suitable method, such as via a double-jacketed pipe or heat exchanger, for example.

Alternatively, other types of polymerization processes may be used, such as stirred reactors in series, parallel or combinations thereof, for example. In one or more embodiments, the polymerization process includes the production of multi-modal polyolefins. For example, one or more embodiments may include passing a slurry through at least two reaction zones (e.g., a multi-modal process). As used herein, the term “multi-modal process” refers to a polymerization process including a plurality of reaction zones (e.g., at least two reaction zones) that produce a polymer exhibiting a multi-modal molecular weight distribution. For example, a single composition including at least one identifiable high molecular weight fraction and at least one identifiable low molecular weight fraction is considered a “bimodal” polyolefin.

The multi-modal polyolefins may be formed via any suitable method, such as via a plurality of reactors in series. The reactors can include any reactors or combination of reactors, as described above. In one or more embodiments, the same catalyst is utilized in both reactors. The high molecular weight fraction and the low molecular weight fraction can be prepared in any order in the reactors, e.g., the low molecular weight fraction may be formed in the first reactor and the high molecular weight fraction in the second reactor, or vise versa, for example.

Upon removal from the reactor, the polymer may be passed to a polymer recovery system for further processing, such as addition of additives and/or extrusion, for example. In particular, embodiments of the invention include blending the polymer with a modifier (i.e., “modification”); which may occur in the polymer recovery system or in another manner known to one skilled in the art. As used herein, the term “modifier” refers to an additive that effectively accelerates phase change from liquid polymer to semi-crystalline polymer (measured by crystallization rates) and may include commercially available nucleators, clarifiers and combinations thereof.

The nucleators may include any nucleator known to one skilled in the art for modifying olefin based polymers. For example, non-limiting examples of nucleators may include carboxylic acid salts, including sodium benzoate, talc, phosphates, metallic-silicate hydrates, organic derivatives of dibenzylidene sorbitol, sorbitol acetals, organophosphate salts and combinations thereof. In one embodiment, the nucleators are selected from Amfine Na-11 and Na-21, commercially available from Amfine Chemical and Hyperform HPN-68 and Millad 3988, commercially available from Milliken Chemical. In one specific embodiment, the modifier includes Hyperform HPN-20E, commercially available from Milliken Chemical.

The modifier is blended with the polymer in a concentration sufficient to accelerate the phase change of the polymer. In one or more embodiments, the modifier may be used in concentrations of from about 0.01 wt. % to about 5 wt. %, or from about 0.01 wt. % to about 3 wt. %, or from about 0.05 wt. % to about 1 wt. % or from about 0.1 wt. % to about 0.2 wt. % by weight of the polymer, for example.

The modifier may be blended with the polymer in any manner known to one skilled in the art. For example, one or more embodiments of the invention include melt blending the ethylene based polymer with the modifier.

It is contemplated that the modifier may be formed into a “masterbatch” (e.g., combined with a concentration of masterbatch polymer, either the same or different from the polymer described above) prior to blending with the polymer. Alternatively, it is contemplated that the modifier may be blended “neat” (e.g., without combination with another chemical) with the polymer.

### Polymer Product

The polymers (and blends thereof) formed via the processes described herein may include, but are not limited to, linear low density polyethylene, elastomers, plastomers, high density polyethylenes, low density polyethylenes, medium density polyethylenes, polypropylene and polypropylene copolymers, for example.

Unless otherwise designated herein, all testing methods are the current methods at the time of filing.

In one or more embodiments, the polymers include ethylene based polymers. As used herein, the term “ethylene based” is used interchangeably with the terms “ethylene polymer” or “polyethylene” and refers to a polymer having at least about 50 wt. %, or at least about 70 wt. %, or at least about 75 wt. %, or at least about 80 wt. %, or at least about 85 wt. % or at least about 90 wt. % polyethylene relative to the total weight of polymer, for example.

The ethylene based polymers may have a density (as measured by ASTM D-792) of from about 0.86 g/cc to about 0.98 g/cc, or from about 0.88 g/cc to about 0.97 g/cc, or from about 0.90 g/cc to about 0.97 g/cc or from about 0.925 g/cc to about 0.97 g/cc, for example.

The ethylene based polymers may have a melt index (MI₂) (as measured by ASTM D-1238) of from about 0.01 dg/min to about 100 dg/min, or from about 0.01 dg/min, to about 25 dg/min, or from about 0.03 dg/min, to about 15 dg/min, or from about 0.05 dg/min, to about 10 dg/min, for example.

In one or more embodiments, the polymers include low density polyethylene. As used herein, the term “low density polyethylene” refers to ethylene based polymers having a density of from about less than about 0.92 g/cc, for example.

In one or more embodiments, the polymers include medium density polyethylene. As used herein, the term “medium density polyethylene” refers to ethylene based polymers having a density of from about 0.92 g/cc to about 0.94 g/cc or from about 0.926 g/cc to about 0.94 g/cc, for example.

In one or more embodiments, the polymers include high density polyethylene. As used herein, the term “high density polyethylene” refers to ethylene based polymers having a density of from about 0.94 g/cc to about 0.97 g/cc, for example.

In one or more embodiments, the polymers include high molecular weight polyethylene. As used herein, the term “high molecular weight polyethylene” refers to ethylene based polymers having a molecular weight of from about 50,000 to about 10,000,000, for example.

In one or more embodiments, the ethylene based polymers may exhibit bimodal molecular weight distributions (i.e., they are bimodal polymers). For example, a single composition including two distinct molecular weight peaks using size exclusion chromatograph (SEC) is considered to be a “bimodal” polyolefin. For example, the molecular weight fractions may include a high molecular weight fraction and a low molecular weight fraction.

The high molecular weight fraction exhibits a molecular weight that is greater than the molecular weight of the low molecular weight fraction. The high molecular weight fraction may have a molecular weight of from about 50,000 to about 10,000,000, or from about 60,000 to about 5,000,000 or from about 65,000 to about 1,000,000, for example. In contrast, the low molecular weight fraction may have a molecular weight of from about 500 to about 50,000, or from about 525 to about 40,000 or from about 600 to about 35,000, for example.

The bimodal polymers may have a ratio of high molecular weight fraction to low molecular weight fraction of from about 80:20 to about 20:80, or from about 70:30 to about 30:70 of from about 60:40 to about 40:60, for example.

### Product Application

The polymers and blends thereof are useful in applications known to one skilled in the art, such as forming operations (e.g., film, sheet, pipe and fiber extrusion and co-extrusion as well as blow molding, injection molding and rotary molding). Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include slit-films, monofilaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, sheet, thermoformed sheet, geomembranes and pond liners, for example. Molded articles include single and multi-layered constructions in the form of bottles, tanks, large hollow articles, rigid food containers and toys, for example.

One or more embodiments of the invention include utilizing the polymers to form pipe articles, such as pipe, tubing, molded fittings, pipe coatings and combinations thereof, for example. The pipe articles may be utilized in industrial/chemical processes, mining operations, gas distribution, potable water distribution, gas and oil production, fiber optic conduit, sewer systems and pipe refining, for example. In one or more embodiment, the pipe articles may have a wall thickness at least about 1 inch, or at least about 1.25 inches or at least about 1.5 inches, for example. In another embodiment, the polymers are utilized to form thermoformed articles or corrugated sheets, for example.

Sag resistance is an important performance characteristic of pipe articles (and may also be important for thermoformed articles and/or corrugated sheets). Excess sag in pipe articles decrease pipe performance (e.g., thinner sections are weaker), resulting in processing difficulties and/or hindering the fluid flow therethrough, for example. Prior attempts to improve sag resistance in pipe articles have included peroxidation. However peroxidation can cause additional problems, such as processing difficulties and/or decreasing slow crack growth resistance in pipe walls, for example.

Unexpectedly, embodiments of the invention are capable of forming pipe articles exhibiting improved resistance to sag. For example, the pipe articles may exhibit an increase in sag resistance of at least about 5%, or at least about 10%, or at least about 20% or at least about 30% compared to pipe articles formed from an identical process absent the modifier, for example. As used herein, “sag resistance” is quantified by measuring the sag of an extruded strand at different take-up speeds.

One or more embodiments of the invention include utilizing the polymers to form blown film, such as sacks and liners. Blown films may be formed by forcing molten polymer through a circular die, which is then blown and the molten polymer is then inflated to form a bubble. The resultant bubble is then flattened and cut into strips, that when rolled, produces rolls of flat film. Some blown film processes, such as those that utilize the specific polymers described herein (e.g., high molecular weight, high density polyethylene), blow the film with a stalk (the melt exits the blown film die as an annulus and it is carried upwards prior to inflation), forming a bubble visually similar to a wine glass, for example. In one or more embodiments, the stalk has a height of at least about 4 die diameters, or at least about 5 die diameters or at least about 6 die diameters, for example. It has been observed that the stalk results in slower cooling than blown film processes absent a stalk.

Unfortunately, blown film processes may experience bubble instability. Bubble instability can include many phenomena, such as draw resonance (DR), generally characterized by aperiodic oscillation of the bubble diameter, helicoidal instability, generally characterized by a helicoidal motion of bubble around its axial direction, frost line height (FLH) instability, generally characterized by variation in the location of FLH and stalk height instability, which is analogous to FLH instability with varying stalk height.

Bubble instability can lead to a less consistent formed article, along with processing difficulties, for example. In addition, if the bubble instability is not reversed, the bubble may break, resulting in shut down of the processing line.

Prior attempts to improve bubble stability have included utilizing additives, such as calcium carbonate and fluoroelastomers, for example. However, such additives have not demonstrated consistent improvement in bubble stability and therefore have limited success depending upon the type of polymer utilized.

Unexpectedly, embodiments of the invention are capable of forming blown films with improved bubble stability. In one or more embodiments, the blown film processes exhibit at least about 5%, or at least about 10%, or at least about 15%, or at least about 20% or at least about 30% improvement in bubble stability compared to identical processes absent the modifier, for example.

In addition, embodiments of the invention are capable of forming blown films exhibiting improved film gauge distribution. The improvement in gauge distribution produces better film appearance and allows for increased ability to downgauge the film. For example, films can be downgauged by increasing winder speeds at least about 10%, or at least about 20%, or at least about 25%, or at least about 30%, or at least about 35% or at least about 40% compared to identical processes absent the modifier.

Other unexpected results may include improved optical properties such as an increase in film gloss. For example, the gloss may be increased by at least about 10%, or at least about 20%, or at least about 25%, or at least about 30%, or at least about 40%, or at least about 50%, or at least about 60% or at least about 70% compared to an identical process absent the modifier. In addition, the film may exhibit a decrease in haze (e.g., at least about 5%, or at least about 10% or at least about 15%). Machine direction (MD) tear (as measured by ASTM D446) may also be decreased with little or no loss in dart impact resistance.

### EXAMPLES

### Example 1

The sag resistance of several pipe resins was compared by measuring the strand sag from extruded samples at different puller speeds. A Brabender extruder equipped with a 19 mm screw and capillary die was used to produce the melt strand. The throughput was kept constant throughout the experimentation. Sample 1A was formed from XT10N (a bimodal polyethylene having a density of 0.9486 g/cc and an MI₅ of 0.24 dg/min.), commercially available from TOTAL PETROCHEMICALS, USA, Inc. Sample 1B was formed by melt blending Sample 1A with a 5 wt % of HL3-4, a nucleator masterbatch containing HPN-20E in LDPE commercially available from Milliken Chemicals. Sample 1C was formed using an experimental bimodal polyethylene reacted with peroxide. The final polyethylene density was 0.949 g/cc and MI₅ of 0.3 dg/min. Sample 1D was formed by melt blending 1C with 5 wt. % HL3-4. The sag distance measured in mm of each strand was visually monitored at varying take up speeds, the results of which are shown in Table 1.

TABLE 1
Sag distance and percent difference with modification

| | 1A | 1B | | 1C | 1D | |
|---|---|---|---|---|---|---|
| Puller speed | (mm) | (mm) | % Difference | (mm) | (mm) | % Difference |
| 2 | 27 | 24 | 11 | 27 | 24 | 14 |
| 1.74 | 47 | 39 | 17 | 48 | 38 | 21 |
| 1.69 | 57 | 44 | 23 | 56 | 44 | 22 |
| 1.64 | 69 | 53 | 23 | 70 | 51 | 27 |
| 1.59 | 99 | 66 | 33 | 89 | 62 | 31 |
| 1.54 | 155 | 96 | 38 | 113 | 80 | 30 |
| 1.49 | | 162 | | 253 | 240 | 5 |

Unexpectedly, Samples 1B and 2D showed a significant increase (i.e., over 30%) at lower take off speeds in sag resistance over Samples 1A and 1C.

### Example 2

Blown films were formed from varying polymer samples. Sample 2A was formed from BDM1 05-11 (a Ziegler-Natta formed bimodal polyethylene having a density of 0.9515 g/cc and an MI₅ of 0.27 dg/min), produced by TOTAL PETROCHEMICALS, USA, Inc. Sample 2B was formed by melt blending Sample 1A with 5 wt % HL3-4, a nucleator masterbach containing HPN-20E in LDPE, commercially available from Milliken Chemicals. Sample 2C was formed by blending 5 wt. % LD105 (a low density polyethylene having a density of 0.923 g/cc and an MI₂ of 0.250 dg/min.), commercially available from ExxonMobil Chemical, and Sample 2A. Sample 2D was formed from 2285 (a Ziegler-Natta formed bimodal polyethylene having a density of 0.951 g/cc and an MI₅ of 0.32 dg/min.), commercially available from TOTAL PETROCHEMICALS, USA. Inc. Sample 2E was formed by melt blending Sample 2D with 5 wt. % of HL3-4.

Blown films were produced using an Alpine film line with a flat temperature profile of 400° F. The film stability was quantified by producing blown film at three neck heights (30, 37, 44″ from die), and a blow-up ratio of 4:1. Stability rankings were recording at each neck heights with the iris closed, and 3 minutes after the iris was fully opened. A numerical ranking of 4 is the highest stability where there are no vertical stability issues (breathing) or bubble dancing. A ranking of 3 indicates slight breathing and dancing (less than 1″ deviation from cener). A ranking of 2 indicates the bubble is breathing or dancing greater than 1″ from center. A ranking of 1 is the lowest ranking where the bubble is exhibiting significant breathing and/or helical rotation all the way to the open iris. A final stability number is calculated by multiplying the data from the three closed rankings and the three open rankings and normalizing using the log scale. The scale for the testing is therefore 0 to 3.61, with 3.61 being the most stable ranking. Unexpectedly, the nucleated samples resulted in improved bubble stability while bubble instability was generally observed with the non-nucleated samples. In particular, Sample 2B resulted in about 33% improvement in bubble stability over Sample 2A.

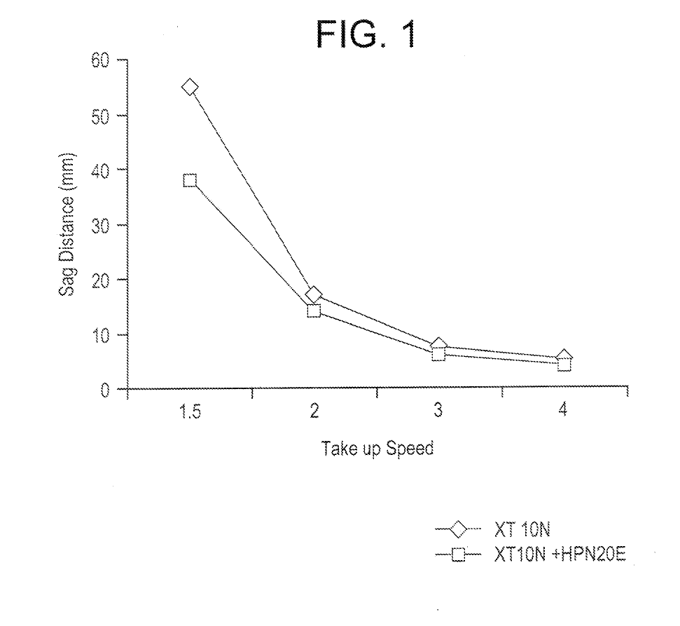

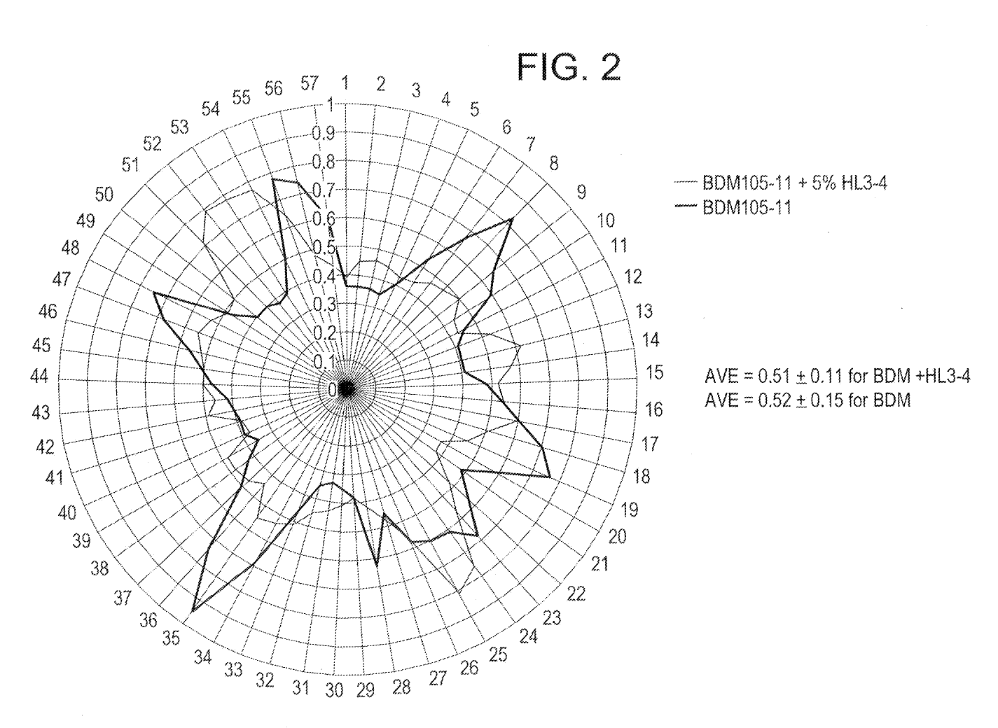

The gauge distribution of several of the films produced was checked to determine the influence of the nucleator addition. While making blown film with Sample 2A, there was evidence of port flow with both flattened areas on the bubble and lines in the finished film (illustrated in FIGS. 1 and 2). However, Sample 2B showed dramatically improved port flow issues such that neither symptom was present with the nucleated blend. This improved gauge distribution allowed for more downgauging of the film.

The effect of downgauging (e.g., increasing the take-off speed during film formation) was also analyzed during processing of the samples. Downgauging was achieved in this example by setting the screw speed to 75 rpm at a constant nip roll speed of 76 m/min and then slowly increasing the speed of the nip roll until a break was induced. While downgauging Sample 2D significant breathing began to occur at a nip speed of 76 m/min. The bubble broke due to instability on average at 98 m/min, giving a final gauge of approximately 0.2 mil. Unexpectedly, Sample 2E showed much better stability under downgauging conditions. No breathing was present at any point in the test and a nip speed of 140 m/min was achieved, yielding a final gauge less than 0.1 mil (0.04 mil) before the bubble broke.

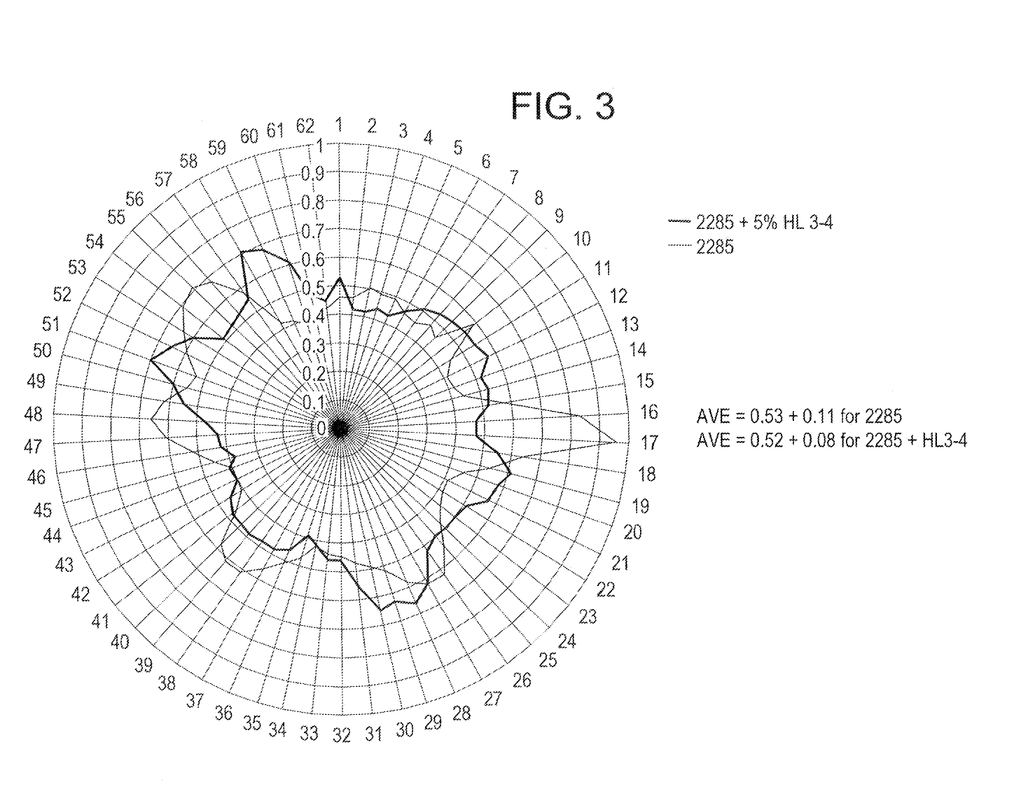

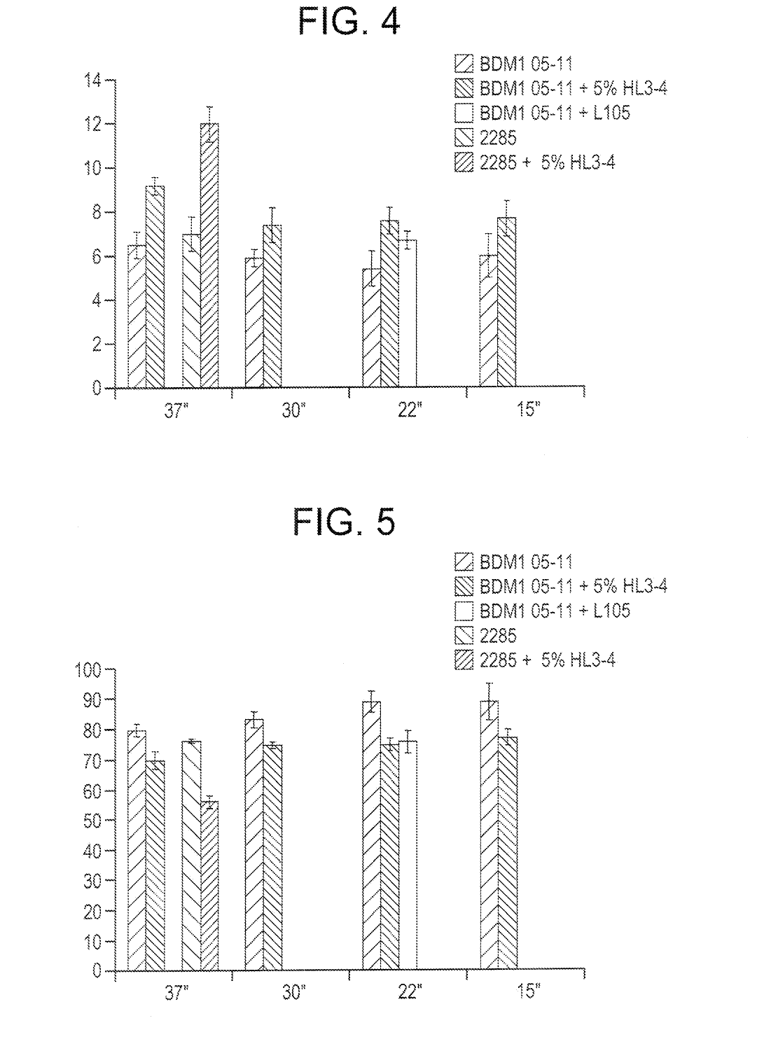

In addition, the optical properties of various samples were measured and are illustrated in FIGS. 3 and 4. As shown in FIG. 3, Sample 2B yielded a 25 to 40 percent improvement in gloss over Sample 2A, depending on the neck height. A reduction in haze of 10 to 14 percent was also observed. As shown in FIG. 4, the difference in gloss was even greater for Sample 2E at 70% improvement over Sample 2D with a reduction in haze of 15%.

Further, as illustrated in FIG. 5, Sample 2B unexpectedly exhibited a reduction in machine direction (MD) tear strength over Sample 2A, but no significant change in transverse (TD) tear or dart impact, shifting the curve to the right due to the increased tear ratio. However, it was observed that the addition of LDPE alone (Sample 2C) does not cause a similar shift in tear ratio. Accordingly, the addition of the nucleator unexpectedly causes a drop in MD tear strength.

While the foregoing is directed to embodiments of the present invention, other and further embodiments of the invention may be devised without departing from the basic scope thereof and the scope thereof is determined by the claims that follow.

What is claimed is:

1. A process of forming a polymer article comprising:
providing a bimodal ethylene based polymer;
blending the bimodal ethylene based polymer with a nucleator to form modified polyethylene;
forming the modified polyethylene into a polymer article, wherein the polymer article is selected from pipe articles and blown films.

2. The process of claim 1, wherein the bimodal ethylene based polymer is formed from a Ziegler-Natta catalyst system, wherein the Ziegler-Natta catalyst system is formed by contacting an alkyl magnesium compound with an alcohol to form a magnesium dialkoxide compound and contacting the magnesium dialkoxide compound with successively stronger chlorinating agents.

3. The process of claim 1, wherein the polymer article is a pipe article and exhibits at least about 5% greater sag resistance than a polymer article prepared via an identical process absent the nucleator.

4. The process of claim 3, wherein the polymer article is prepared in the absence of peroxidation.

5. The process of claim 3, wherein the pipe article exhibits at least about 30% greater sag resistance than a polymer article prepared via an identical process absent the nucleator.

6. The process of claim 1, wherein the polymer article is a blown film and exhibits at least about 10% increase in bubble stability than a polymer article prepared via an identical process absent the nucleator.

7. The process of claim 1, wherein the modified polyethylene comprises from about 0.01 wt. % to about 3 wt. % nucleator.

8. The process of claim 1, wherein the polymer article exhibits a haze that is at least about 10% less than a polymer article prepared via an identical process absent the nucleator.

9. The process of claim 1, wherein the ethylene based polymer exhibits a density of at least about 0.940 g/cc.

10. The process of claim 1, wherein the ethylene based polymer exhibits a molecular weight of at least about 50,000.

11. The process of claim 1, wherein the bimodal ethylene based polymer exhibits a high molecular weight fraction comprising a molecular weight of from about 50,000 to about 10,000,000 and a low molecular weight fraction comprising a molecular weight of from about 500 to about 50,000.

12. The process of claim 11, wherein the ethylene based polymer exhibits a ratio of high molecular weight fraction to low molecular weight fraction of from about 80:20 to about 20:80.

13. A polymer article formed from the process of claim 1.

14. A pipe formed from the process of claim 3.

15. A blown film formed from the process of claim 6.

16. The process of claim 1, wherein the polymer article exhibits a gloss that is at least about 25% higher than a polymer article prepared via an identical process absent the nucleator.

17. The blown film of claim 15, wherein the blown film exhibits at least about a 10% increase in an ability to downgauge than a polymer article prepared via an identical process absent the nucleator.
